(19) United States
(12) Patent Application Publication
(10) Pub. No.: US 2009/0150877 A1
(43) Pub. Date: Jun. 11, 2009

(54) Data driven communication protocol grammar

(75) Inventors: David Bradley Markisohn, Indianapolis, IN (US); Morris J. Young, Indianapolis, IN (US); Allen B. Cummings, Westfield, IN (US)

Correspondence Address: BAKER & DANIELS LLP / ROCHE, 300 NORTH MERIDIAN STREET, SUITE 2700, INDIANAPOLIS, IN, 46204, US

(73) Assignee: Roche Diagnostics Operations, Inc., Indianapolis, IN (US)

(21) Appl. No.: 11/999,770

(22) Filed: Dec. 7, 2007

(51) Int. Cl. G06F 9/54; G06F 9/44

(52) U.S. Cl. 717/168; 719/328

(57) ABSTRACT

An application software is provided which communicates with one or more resources having resource specific communication grammars. Grammar for each resource specific communication grammar is provided in a location external to the application software and is used by the application software to generate a communication stack for communicating with the respective resource.

### FIELD OF THE INVENTION

The present invention relates generally to communicating between a computing device and a resource through resource specific communication grammars which are stored external to the application software being executed by the computing device.

### BACKGROUND OF THE INVENTION

A computing device that communicates with a plurality of different devices, such as medical devices, each of which has their own communication protocol grammars has the device specific communication protocol grammars hard coded into the application software. As such, to extend the computing device to a new device requires code changes to the application software that result in updated binary files. Even small changes to the application software (such as adding support for a previously unsupported command or command structure in a device specific communication protocol grammar) require extensive code changes and development.

### SUMMARY OF THE INVENTION

The present invention relates generally to communicating between an application software being executed by a computing device and a resource through resource specific communication grammars which are stored external to the application software being executed by the computing device. Exemplary resources include files, a new device, a new transport, a new network piece, and other suitable items that communicate with the application software being executed by the computing device. The resource specific communication grammars specify various commands used by the resource, the command structure for such commands, expected responses to the commands, and the response structure for such responses. In one embodiment, the application software is a healthcare management software application. Exemplary healthcare management software applications include blood glucose monitoring software applications and exemplary resources for use therewith include blood glucose meters and insulin pumps.

In an exemplary embodiment of the present disclosure, a computer readable media is provided. The computer readable media including an application software for communication with a plurality of resources; and a plurality of communication grammars stored separate from the application software. Each of the plurality of communication grammars being associated with a respective resource.

In another exemplary embodiment of the present disclosure, a method for facilitating communication with a resource is provided. The method including the steps of: determining that the resource is available for communication; providing communication grammar for the resource in a file external to an application software used to communicate with the resource; and generating a communication stack for communication with the resource based on the externally stored communication grammar.

In a further exemplary embodiment of the present disclosure, a method of adding communication grammar for a new resource for communication with an application software is provided. The method including the steps of: storing on a memory accessible by a computing device executing the application software a file containing the communication grammar for the new resource; and generating with the computing device a dynamically generated communication stack based on the communication grammar.

Additional features and advantages of the present invention will become apparent to those skilled in the art upon consideration of the following detailed description of illustrative embodiments exemplifying the best mode of carrying out the invention as presently perceived.

### BRIEF DESCRIPTION OF DRAWINGS

The detailed description of the drawings particularly refers to the accompanying figures in which:

FIG. 1 is a representation of an exemplary computing device receiving information from a remote resource, another computing device, a medical device.

FIG. 2 is a representation of the computing device of FIG. 1 and the plurality of computing devices that the computing device communicates with through a transport;

FIG. 3 is a representation of a communication path between the computing device of FIG. 1 and one of the plurality of computing devices of FIG. 2.

FIG. 4 is a representation of an application software of the computing device of FIG. 1 having a plurality of computing device specific communication grammar information provided in an external configuration file.

FIG. 5A is a representation of a computing device specific communication grammar information of FIG. 4.

FIG. 5B is a representation of a first computing device specific communication grammar information and a second computing device specific communication grammar information.

FIG. 6 is a representation of a communication from a first application software of a first computing device having a first communication stack to a second application software of a second computing device having a second communication stack.

FIG. 7 is a representation of a user interface of a healthcare application software.

### DETAILED DESCRIPTION OF THE DRAWINGS

The embodiments of the invention described herein are not intended to be exhaustive or to limit the invention to the precise forms disclosed. Rather, the embodiments selected for description have been chosen to enable one skilled in the art to practice the invention.

Concepts described herein may be further explained in one of more of the co-filed patent applications entitled HELP UTILITY FUNCTIONALITY AND ARCHITECTURE (Atty Docket: ROCHE-P0033), METHOD AND SYSTEM FOR GRAPHICALLY INDICATING MULTIPLE DATA VALUES (Atty Docket: ROCHE-P0039), SYSTEM AND METHOD FOR DATABASE INTEGRITY CHECKING (Atty Docket: ROCHE-P0056), METHOD AND SYSTEM FOR DATA SOURCE AND MODIFICATION TRACKING (Atty Docket: ROCHE-P0037), PATIENT-CENTRIC HEALTHCARE INFORMATION MAINTENANCE (Atty Docket: ROCHE-P0043), EXPORT FILE FORMAT WITH MANIFEST FOR ENHANCED DATA TRANSFER (Atty Docket: ROCHE-P0044), GRAPHIC ZOOM FUNCTIONALITY FOR A CUSTOM REPORT (Atty Docket: ROCHE-P0048), METHOD AND SYSTEM FOR SELECTIVE MERGING OF PATIENT DATA (Atty Docket: ROCHE-P0065), METHOD AND SYSTEM FOR PERSONAL MEDICAL DATA DATABASE MERGING (Atty Docket: ROCHE-P0066), METHOD AND SYSTEM FOR WIRELESS DEVICE COMMUNICATION (Atty Docket: ROCHE-P0034), METHOD AND SYSTEM FOR SETTING TIME BLOCKS (Atty Docket: ROCHE-P0054), METHOD AND SYSTEM FOR ENHANCED DATA TRANSFER (Atty Docket: ROCHE-P0042), COMMON EXTENSIBLE DATA EXCHANGE FORMAT (Atty Docket: ROCHE-P0036), METHOD OF CLONING SERVER INSTALLATION TO A NETWORK CLIENT (Atty Docket: ROCHE-P0035), METHOD AND SYSTEM FOR QUERYING A DATABASE (Atty Docket: ROCHE-P0049), METHOD AND SYSTEM FOR EVENT BASED DATA COMPARISON (Atty Docket: ROCHE-P0050), DYNAMIC COMMUNICATION STACK (Atty Docket: ROCHE-P0051), SYSTEM AND METHOD FOR REPORTING MEDICAL INFORMATION (Atty Docket: ROCHE-P0045), METHOD AND SYSTEM FOR MERGING EXTENSIBLE DATA INTO A DATABASE USING GLOBALLY UNIQUE IDENTIFIERS (Atty Docket: ROCHE-P0052), METHOD AND SYSTEM FOR ACTIVATING FEATURES AND FUNCTIONS OF A CONSOLIDATED SOFTWARE APPLICATION (Atty Docket: ROCHE-P0057), METHOD AND SYSTEM FOR CONFIGURING A CONSOLIDATED SOFTWARE APPLICATION (Atty Docket: ROCHE-P0058), METHOD AND SYSTEM FOR DATA SELECTION AND DISPLAY (Atty Docket: ROCHE-P0011), METHOD AND SYSTEM FOR ASSOCIATING DATABASE CONTENT FOR SECURITY ENHANCEMENT (Atty Docket: ROCHE-P0041), METHOD AND SYSTEM FOR CREATING REPORTS (Atty Docket: ROCHE-P0046), METHOD AND SYSTEM FOR CREATING USER-DEFINED OUTPUTS (Atty Docket: ROCHE-P0047), HEALTHCARE MANAGEMENT SYSTEM HAVING IMPROVED PRINTING OF DISPLAY SCREEN INFORMATION (Atty Docket: ROCHE-P0031), and METHOD AND SYSTEM FOR MULTI-DEVICE COMMUNICATION (Atty Docket: ROCHE-P0064), the entire disclosures of which are hereby expressly incorporated herein by reference. It should be understood that the concepts described herein may relate to diabetes management software systems for tracking and analyzing health data, such as, for example, the ACCU-CHEK® 360° product provided by Roche Diagnostics. However, the concepts described herein may also have applicability to apparatuses, methods, systems, and software in fields that are unrelated to healthcare. Furthermore, it should be understood that references in this patent application to devices, meters, monitors, pumps, or related terms are intended to encompass any currently existing or later developed apparatus that includes some or all of the features attributed to the referred to apparatus, including but not limited to the ACCU-CHEK® Active, ACCU-CHEK® Aviva, ACCU-CHEK® Compact, ACCU-CHEK® Compact Plus, ACCU-CHEK® Integra, ACCU-CHEK® Go, ACCU-CHEK® Performa, ACCU-CHEK® Spirit, ACCU-CHEK® D-Tron Plus, and ACCU-CHEK® Voicemate Plus, all provided by Roche Diagnostics or divisions thereof.

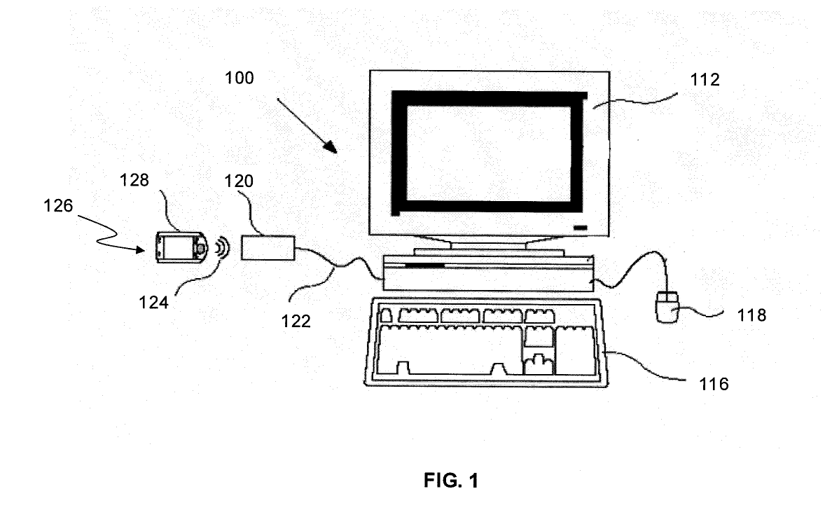

Referring to FIG. 1, a computing device 100 is shown. Computing device 100 may be a general purpose computer or a portable computing device. Although computing device 100 is illustrated as a single computing device, it should be understood that multiple computing devices may be used together, such as over a network or other methods of transferring data. Exemplary computing devices include desktop computers, laptop computers, personal data assistants (“PDA”), such as BLACKBERRY brand devices, cellular devices, tablet computers, infusion pumps, blood glucose meters, or an integrated device including a glucose measurement engine and a PDA or cell phone.

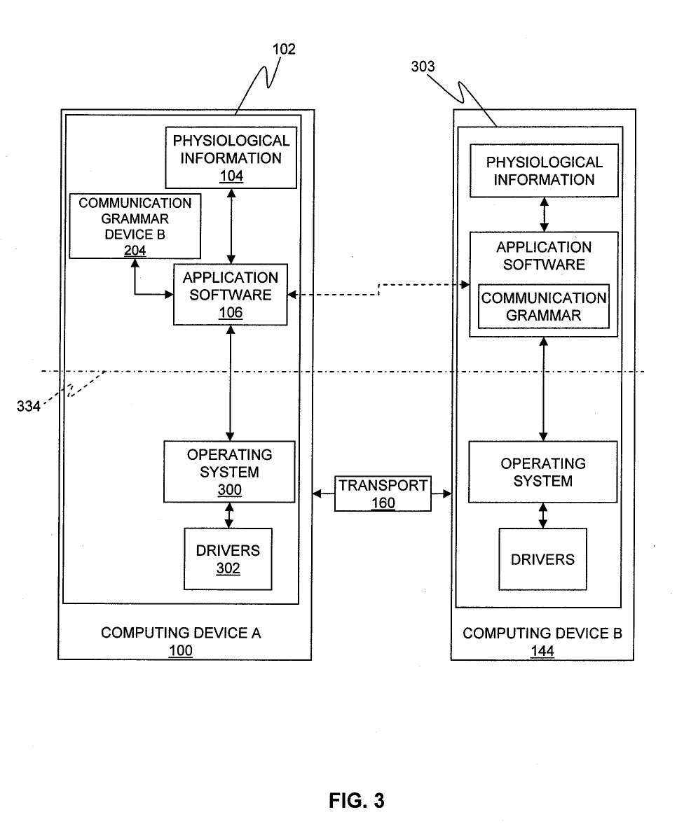

Computing device 100 has access to a memory 102 (see FIG. 3). Memory 102 is a computer readable medium and may be a single storage device or multiple storage devices, located either locally with computing device 100 or accessible across a network. Computer-readable media may be any available media that can be accessed by the computer 102 and includes both volatile and non-volatile media. Further, computer readable-media may be one or both of removable and non-removable media. By way of example, and not limitation, computer-readable media may comprise computer storage media. Exemplary computer storage media includes, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which can be used to store the desired information and which can be accessed by the computing device 100.

Memory 102 includes an application software system 106. In one embodiment, application software system 106 is a healthcare management software system. Healthcare management software system 106 includes instructions which when executed by computing device 100 presents physiological information 104 or information based on physiological information 104 to an output device. Exemplary information presented by healthcare management software application 106 to an output device, such as display 112, include diaries of blood glucose values and reports showing a plurality of blood glucose values. Exemplary reports include standard day reports wherein the blood glucose values are grouped according to the time of day taken, standard week reports wherein the blood glucose values are grouped according to the day of the week taken, trend graphs to illustrate temporal trends in blood glucose values, and other suitable reports. Exemplary output devices include fax machines, displays, printers, and files.

Computing device 100 is coupled to an output device, illustratively a display 112. Computing device 100 is further coupled to a plurality of input devices 114. A first exemplary input device is a keyboard 116. A second exemplary input device is a mouse 118. A third exemplary input device is a modulated signal transceiver 120, in electronic communication with computer 100 through a cable 122. Transceiver 120 is configured to transmit and receive a modulated signal 124 and to establish communications to and from a remote device 126. An exemplary remote device 126 is a blood glucose meter 128.

In one embodiment, blood glucose meter 128 is assigned to a patient and associated with that patient in healthcare management software system 106. Thus, when physiological information 104 from blood glucose meter 128 is transferred to healthcare management software system 106, the physiological information 104 from blood glucose meter 128 automatically populates database records in a patient database relating to that patient.

Although a blood glucose meter 128 is shown, any medical device may be implemented having data to be used by healthcare management software system 106. Medical devices 128 are devices capable of recording patient data and transferring data to software applications and may include monitors which record values of measurements relating to a patient's state and information such as the time and date when the measurement was recorded. Medical devices may also be devices configured to provide medications to patients such as, for example, insulin pumps. These devices, generally, record dosage amounts as well as the time and date when the medication was provided. It should be understood that the functionality of medical device 128 may be included within an exemplary computing device 100.

Computing device 100 may be used by the patient, a caregiver, or anyone having relevant data pertaining to a patient. Computing device 100 may be located in a patient's home, a healthcare facility, a drugstore, a kiosk, or any other convenient place. In an alternative embodiment, computing device 100 may be connected to a remote computing device, such as at a caregiver's facility or a location accessible by a caregiver, and physiological information 104, such as in a patient database, may be transferred between them. In this embodiment, computing device 100 and the remote device are configured to transfer physiological information 104, between them through a data connection such as, for example, via the Internet, cellular communications, or the physical transfer of a memory device such as a diskette, USB key, compact disc, or other portable memory device. Computing device 100 and/or the remote device, may be configured to receive physiological information 104 from a medical device or, alternatively, to receive physiological information 104 transferred from the other of computing device 100 and the remote device.

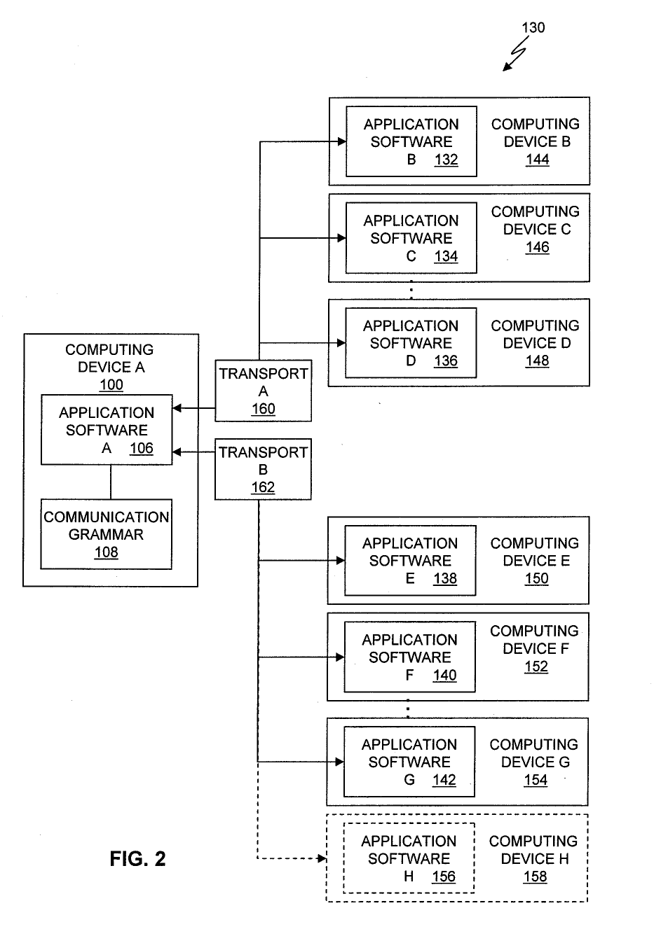

Referring to FIG. 2, application software 106 of computing device 100 needs to be able to communicate with various other application softwares 130. Exemplary application softwares 130 include application software 132, application software 134, application software 136, application software 138, application software 140, and application software 142. Application softwares 132-142 may be the application software for a variety of medical devices 144-154, respectively. Exemplary medical devices 144-154 include blood glucose meters 128 and insulin pumps.

Computing device 100 communicates with one of medical devices 144-148 through a first transport 160 or communicates with one of medical devices 150-154 through a second transport 162. Exemplary transports 160 and 162 may be either a wired communication transport or a wireless communication transport. An exemplary transport is a transceiver 120 for an infrared communication, such as IrDA. An exemplary transport is a SmartPix USB cable which is hardware cable used to communicate with blood glucose meters and insulin pumps via infrared.

In addition to application softwares 132-142 of medical devices 144-154, application software 106 needs to be extendable to additional application software 156 running on one of medical devices 144-154 or an additional medical drive 158, such as a new blood glucose meter or a new insulin pump. In order to easily accommodate the additional software 156, application software 106 uses externally stored communication grammar 108 to control its communication with the respective application software 132-142. For example, if an application software 132 running on medical device 144 is detected as being connected to computing device 100, application software 106 running on computing device 100 based on the externally stored communication grammar 108 generates a communication stack to provide the available commands recognized by application software 132, the structure of such commands, the expected responses to such commands from application software 132, and the structure of such responses. Therefore, the addition of a new application software 156 is accommodated by providing the available commands recognized by application software 156, the structure of such commands, the expected responses to such commands from application software 156, and the structure of such responses in the externally stored communication grammar 108. Application software 106 running on computing device 100 then will generate a communication stack to communicate with application software 156 running on medical device 158 based on the available commands recognized by application software 156, the structure of such commands, the expected responses to such commands from application software 156, and the structure of such responses in the externally stored communication grammar 108.

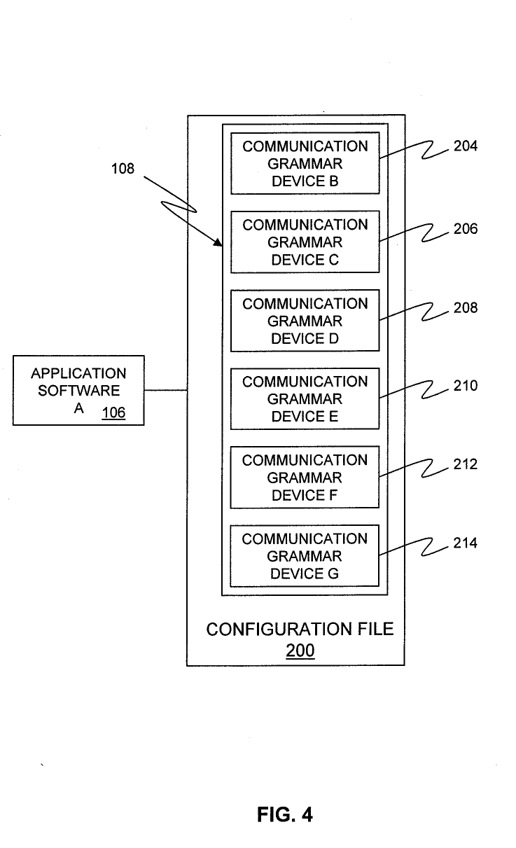

Referring to FIG. 4, in one embodiment, communication grammar 108 is stored in a configuration file 200 stored externally to application software 106. In one embodiment, configuration file 200 is a single file. In one embodiment, configuration file 200 is a collection of a plurality of files. Illustratively, configuration file includes specific communication grammars 204-214 for the respective application software 132-142 running on computing devices 144-154, respectively. In one embodiment, configuration file 200 is an encrypted file. Known encryption techniques may be used to encrypt configuration file 200. An exemplary encryption technique is to determine a digest of configuration file 200 and then encrypt with a private key. This produces a signed encrypted configuration file 200. In one embodiment, configuration file 200 is not an encrypted file. In one embodiment, wherein configuration file 200 is unencrypted an assurance of the contents of configuration file 200 may be made through other ways, such as whether the configuration file is stored on a read only media or a checksum.

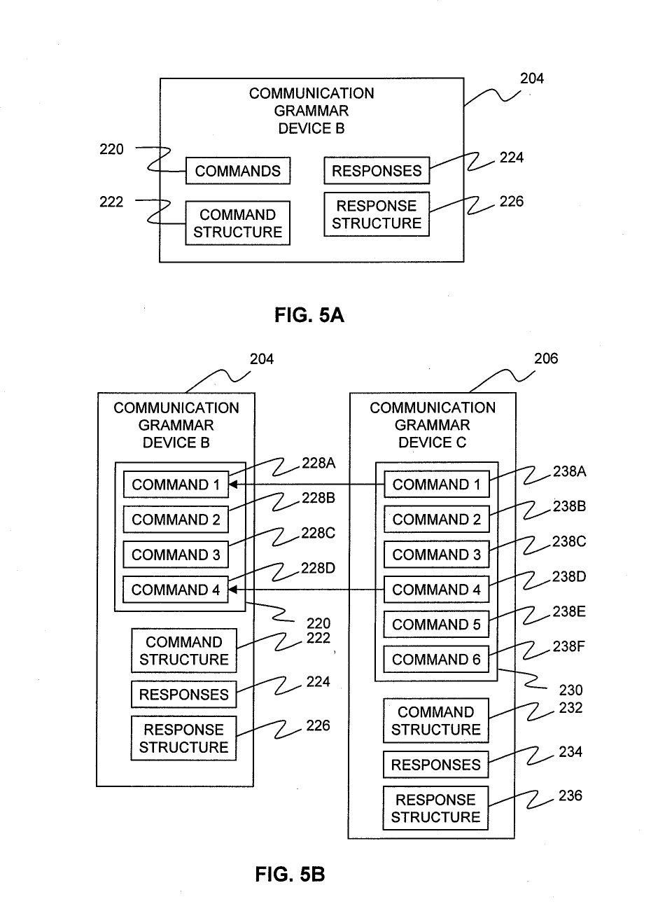

Referring to FIG. 5A, a representation of the communication grammar 204 for application software 132 being executed by device 144. Communication grammar 204 includes a plurality of commands 220, a command structure 222, a plurality of expected responses 224 for respective commands, and a response structure 226. In one embodiment, each of the communication grammars 204-214 are independent.

In one embodiment, at least one of the communication grammars 204-214 utilizes a portion of one of the other communication grammars 204-214. Referring to FIG. 5B, the communication grammar 206 for application software 134 being executed by computing device 146 utilizes part of the communication grammar 204 for application software 132 being executed by computing device 144. Communication grammar 206 includes a plurality of commands 230, a command structure 232, a plurality of expected responses 234 for respective commands, and a response structure 236. Commands 220 of communication grammar 204 includes commands 228A-D. Commands 230 of communication grammar 204 includes commands 238A-F. In one example commands 228A-D of communication grammar 204 and the corresponding commands 238A-D of communication grammar 206 perform generally the same respective functions. Command 238A is the same as command 228A. Thus, communication grammar 206 references command 228A of communication grammar 204. Commands 238B and 238C perform generally the same function as commands 228B and 228C, but are slightly different. As such, communication grammar 206 does not reference communication grammar 204. Command 238D is the same as command 228D. Thus, communication grammar 206 references command 228D of communication grammar 204. Commands 230 further include additional commands 238E and 238F not provided as part of commands 220. Additional commands 238E and 238F may be a part of a new software version. In one embodiment, communication grammar 204 and communication grammar 206 are stored in a single file. In one embodiment, communication grammar 204 and communication grammar 206 are stored in a separate files.

Referring to FIG. 3, computing device 100 has access to a memory 102 which includes physiological information 104, application software 106, and communication grammar 108. Exemplary physiological information 104 includes blood glucose values, A1c values, Albumin values, Albumin excretion values, body mass index values, blood pressure values, carbohydrate values, cholesterol values (total, HDL, LDL, ratio) creatinine values, fructosamine values, HbAlvalues, height values, insulin dose values, insulin rate values, total daily insulin values, ketone values, microalbumin values, proteinuria values, heart rate values, temperature values, triglyceride values, and weight values. Physiological information 104 may be provided directly by the patient, provided by a caregiver, and/or provided by one or more sensors. Exemplary sensors are provided in insulin pumps and glucose meters.

Memory 102 further includes an operating system 300 and one or more drivers 302. In a similar manner, computing device 144 has access to a memory 303 which includes physiological information 304, application software 306, and communication grammar 308. Unlike communication grammar 108 of computing device 100 which is external to application software 106, communication grammar 308 is a part of application software 306. In one embodiment, communication grammar 308 is external to application software 306. Memory 302 further includes an operating system 310 and one or more drivers 312.

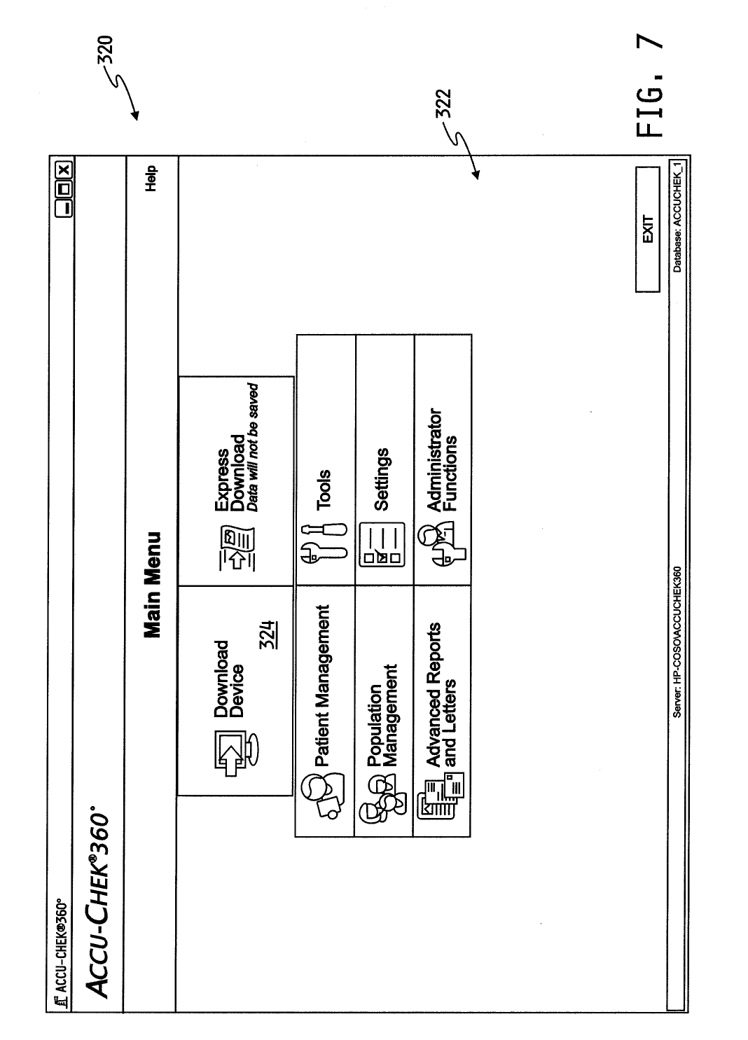

A user through application software 106 sends a request to application software 308. In one embodiment, application software 106 is a healthcare management software application, such as a diabetes care management software application and application software 306 is a healthcare management software application, such as a blood glucose meter application. In one example, an operator may request to download the physiological information 304 stored in memory 303 to physiological information 104, such as a patient database accessible by application software 106. Referring to FIG. 7, an exemplary user interface 320 of a healthcare management software application is shown. Screen 322 includes a first selection input 334 to request a download of physiological information 304 stored in memory 303 to physiological information 104, such as a patient database accessible by the healthcare management software application.

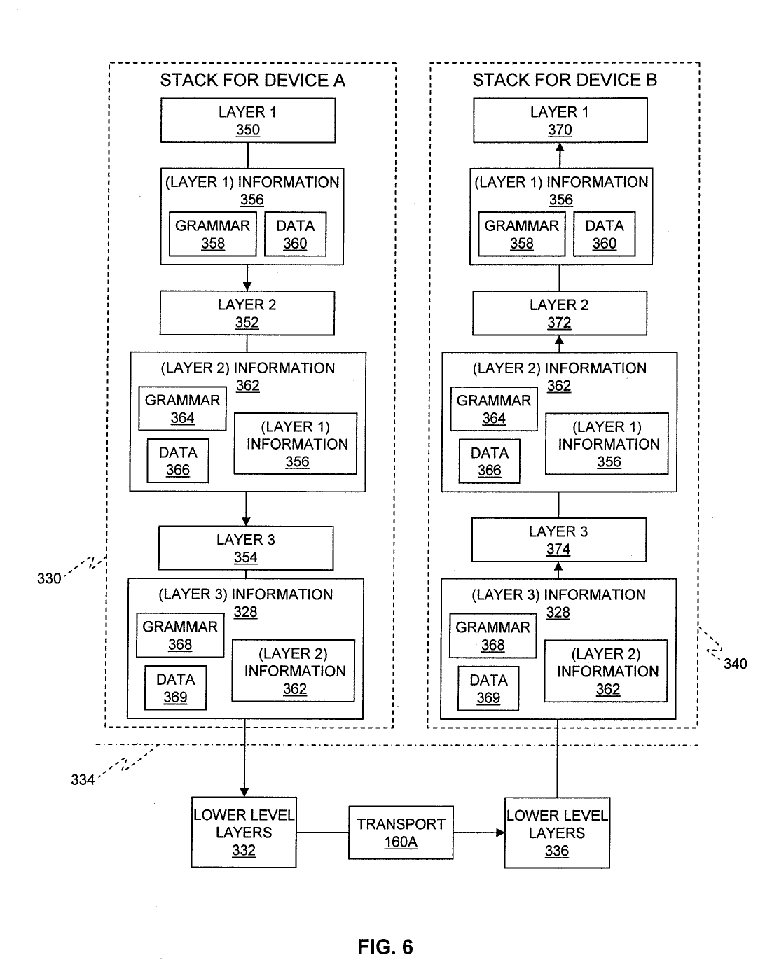

This request to download physiological information 304 is sent from application software 106 to application software 306. It is not sent directly though. The communication grammar specific for application software 306, communication grammar 204, is used to dynamically generate a communication stack 330 (see FIG. 6) for communicating the request to application software 306. Communication stack 330 may take into account the grammar for application software 306, the specific type of device executing application software 306, and/or the transport 160 being used to communicate with application software 306.

The communication stack 330 as explained below includes multiple layers which based on communication grammar 204 generates and formats a communication 328 to application software 306. Additional details regarding the dynamic generation of communication stack 330 are provided in U.S. patent application Ser, No. (unknown), filed Nov. 30, 2007, titled DYNAMIC COMMUNICATION STACK, Atty docket ROCHE-P051, the disclosure of which is expressly incorporated by reference herein. In one embodiment, communication 328 includes a sequence of commands, such as a sequence of commands to wake up a meter.

The communication 328 generated and formatted by communication stack 330 is passed to lower level control 332 as represented by dashed line 334 in FIG. 3. Lower level control 332 includes operating system 300. At lower level control the communication 328 generated and formatted by communication stack 330 is further formatted and transmitted over transport 160 to lower level 336 of computing device 144. The communication may be sent by lower level 332 as a plurality of messages. The lower level formatting of lower level 332 is understood by lower level 336 which presents the communication 328 generated and formatted by communication stack 330 to application software 306. Since the communication 328 generated and formatted by communication stack 330 is formatted based on the communication grammar 204 used by application software 306 (communication stack 340 in FIG. 6), application software 306 is able to understand the communication 328.

Application software 306 in turn generates a response communication to the received communication. The response communication is generated and formatted by communication stack 340 and received by communication stack 330. Exemplary response communications include the physiological information 304, an indication that there is no physiological information 304, or an indication of an error.

This communication process is further represented in FIG. 6. As illustrated in FIG. 6, communication stack 330 and communication stack 340 each include three layers 350-354 and 370-374, respectively. Each layer 350-354 provides grammar information which is understood by the corresponding layer 370-374 and/or data. Although three layers are shown for both communication stack 330 and communication stack 340, more or less layers may be included in both communication stack 330 and communication stack 340.

Layer 350 based on the request received through selection input 324 generates a first communication 356 including grammar 358 (such as a command) and/or data 360. First communication 356 passes onto layer 352. Layer 352 based on first communication 356 generates a second communications 362 including first communication 356 and grammar 364 and/or data 366. Second communication 362 is passed onto layer 354. Layer 354 based on second communication 362 generates a third communications 328 including second communication 362 and grammar 368 and/or data 369. Second communication 362 is passed onto lower level layers 332 which format communication 328 for transport over transport 160. In one embodiment, the lower level layers 332 and the lower level layers 336 include grammar related to the .NET communication system available from Microsoft Corporation of Redmond, Wash. or other common data format communication systems.

Lower level layers 336 receive the communications sent over transport 160 by lower level layers 332 and utilize the grammar included therein to present communication 328 to layer 374 of application software 340. Layer 374 based on grammar 386 and/or data 369 presents communication 362 to layer 372. Layer 372 based on grammar 384 and/or data 366 presents communication 356 to layer 370. Application software 132 then processes the request and generates a response which is communicated in reverse to application software 106.

Although the invention has been described in detail with reference to certain preferred embodiments, variations and modifications exist within the spirit and scope of the invention as described and defined in the following claims.

1. A computer readable media, including:
an application software for communication with a plurality of resources; and
a plurality of communication grammars stored separate from the application software, each of the plurality of communication grammars being associated with a respective resource.

2. The computer readable media of claim 1, wherein the application software includes instructions to generate a first communication stack for a first resource based on a first communication grammar of the plurality of communication grammars.

3. The computer readable media of claim 1, wherein each of the plurality of communication grammars include a plurality of commands recognized by the respective resource and a plurality of expected responses which may be generated by the respective resource.

4. The computer readable media of claim 4, wherein each of the plurality of communication grammars include a command structure and an expected response structure.

5. The computer readable media of claim 1, wherein the plurality of communication grammars are stored in a configuration file.

6. The computer readable media of claim 1, wherein the plurality of communication grammars are stored in an encrypted file.

7. The computer readable media of claim 1, wherein a first communication grammar including a first plurality of commands and a second communication grammar includes a second plurality of commands, the second plurality of commands referencing the first plurality of commands for a plurality of common commands.

8. A method of facilitating communication with a resource, including the steps of:
determining that the resource is available for communication;
providing communication grammar for the resource in a file external to an application software used to communicate with the resource; and
generating a communication stack for communication with the resource based on the externally stored communication grammar.

9. The method of claim 8, further including the step of updating the communication grammar for the resource by updating the file.

10. A method of adding communication grammar for a new resource for communication with an application software, the method including the steps of:
storing on a memory accessible by a computing device executing the application software a file containing the communication grammar for the new resource; and
generating with the computing device a dynamically generated communication stack based on the communication grammar.

11. The method of claim 10, wherein the communication grammar includes a plurality of commands and a plurality of expected responses from the new resource.

12. The method of claim 10, wherein the file is modified to include the communication grammar for the new resource.

13. The method of claim 12, wherein the file further contains at least one additional communication grammar for an additional resource.

14. The method of claim 10, wherein the file is a collection of separate files, a first file including a communication grammar for an additional resource and a second file including the communication grammar for the new resource.

15. The method of claim 14, wherein the communication grammar of the new resource in the second file references the communication grammar of the additional resource in the first file.
